(19) United States
(12) Patent Application Publication
(10) Pub. No.: US 2014/0316859 A1
(43) Pub. Date: Oct. 23, 2014

(54) Setting up Milestones for Desired Performance

(71) Applicant: CloudLogix, LLC, Denver, CO (US)

(72) Inventors: Robert K. Langhorne, III, Grapevine, TX (US); John Millhouse, Garran (AU)

(21) Appl. No.: 14/254,767

(22) Filed: Apr. 16, 2014

Related U.S. Application Data
(60) Provisional application No. 61/812,948, filed on Apr. 17, 2013.

(51) Int. Cl. G06Q 10/06; G06N 5/02; G06N 5/04

(52) U.S. Cl. CPC G06Q 10/0637; G06N 5/048; G06N 5/025
USPC 705/7.36; 706/52; 706/47

(57) ABSTRACT

Various implementations described herein are directed to a non-transitory computer readable medium having stored thereon computer-executable instructions which, when executed by a computer, may cause the computer to receive a desired uptime for one or more pieces of equipment. The computer may receive a set of supplies used in maintaining the one or more pieces of equipment. The computer may determine a plurality of actions for achieving the desired uptime based on a probability analysis of one or more maintenance records for the one or more pieces of equipment. The plurality of actions includes ordering one or more supplies in the set of supplies. The computer may create one or more milestones from the plurality of actions.

### CROSS-REFERENCE TO RELATED APPLICATIONS

This application claims the benefit of U.S. Provisional Patent Application Ser. No. 61/812,948, filed Apr. 17, 2013 and titled SUPPLY CHAIN SOFTWARE, the disclosure of which is incorporated herein by reference.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Supply chain software may examine past data and other trends to predict future needs. Supply chain software may be used in supply chain management to make decisions relating to the supply chain.

### SUMMARY

Described herein are implementations of various technologies for determining actions for achieving a desired uptime. In one implementation, a non-transitory computer-readable medium having stored thereon computer-executable instructions which, when executed by a computer, cause the computer to: receive a desired uptime for one or more pieces of equipment; receive a set of supplies used in maintaining the one or more pieces of equipment; determine a plurality of actions for achieving the desired uptime based on a probability analysis of one or more maintenance records for the one or more pieces of equipment; and create one or more milestones from the plurality of actions. The plurality of actions includes ordering one or more supplies in the set of supplies.

Described herein are also implementations of various technologies for creating one or more milestones for achieving a desired uptime. In one implementation, a non-transitory computer-readable medium having stored thereon computer-executable instructions which, when executed by a computer, cause the computer to: receive a desired uptime for one or more pieces of equipment; receive a set of maintenance actions used in maintaining the one or more pieces of equipment; determine a plurality of actions for achieving the desired uptime based on a probability analysis of one or more maintenance records for the one or more pieces of equipment; and create one or more milestones from the plurality of actions. The plurality of actions includes performing one or more maintenance actions in the set of maintenance actions.

Described herein are also implementations of various technologies for using a set of penalties and a set of contractual obligations to determine an order in which the contractual obligations are to be completed. In one implementation, a non-transitory computer-readable medium having stored thereon computer-executable instructions which, when executed by a computer, cause the computer to perform various actions. The actions may include receiving a set of contractual obligations. The actions may include receiving a set of penalties corresponding to the contractual obligations. The actions may include using the set of penalties and the set of contractual obligations to determine an order in which the contractual obligations in the set of contractual obligations are to be completed to reduce the amount of penalties. The actions may also include creating one or more milestones. The one or more milestones include completing one or more of the contractual obligations in the determined order.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a flow diagram of a method for achieving a desired uptime for one or more pieces of equipment in accordance with implementations of various techniques described herein.

FIG. 2 illustrates a flow diagram of a method for completing obligations in accordance with implementations of various techniques described herein.

FIG. 3 illustrates a flow diagram of a method for milestone management in accordance with implementations of various techniques described herein.

FIG. 4 illustrates a flow diagram of a hierarchical rule fetch method in accordance with implementations of various techniques described herein.

FIG. 5 illustrates a milestone input interface in accordance with various implementations described herein.

FIG. 6 illustrates a message display interface in accordance with various implementations described herein.

FIG. 7 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and “downwardly”; “below” and “above”; and other similar terms indicating relative positions above or below a given point or element may be used in connection with some implementations of various technologies described herein.

Various implementations described herein are directed to creating a series of milestones to achieve a desired uptime for equipment, or to complete contractual obligations. The milestones may be completed using milestone management software. In one implementation, various implementations described herein may be cloud software services.

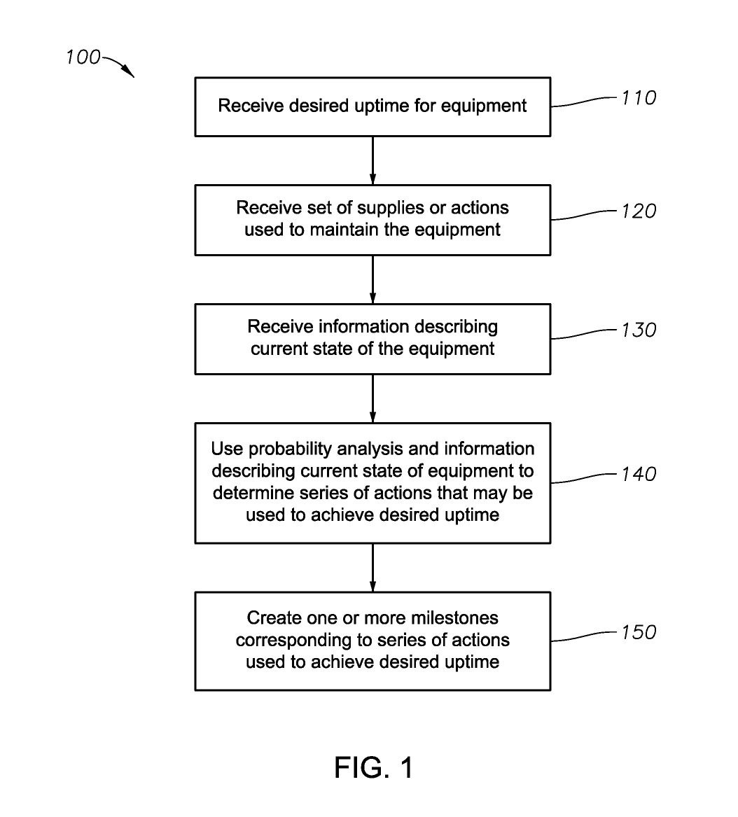

Various implementations for resource allocation will now be described in more detail with reference to FIGS. 1-7.

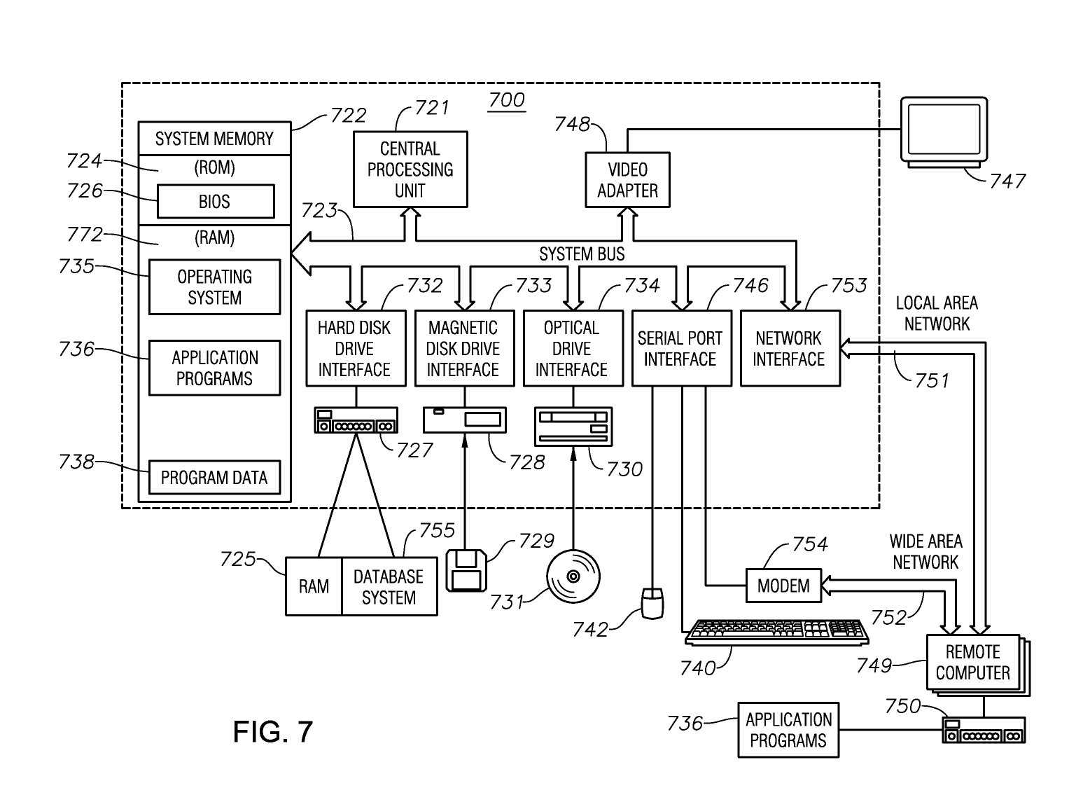

FIG. 1 illustrates a flow diagram of a method 100 for achieving a desired uptime for one or more pieces of equipment in accordance with implementations of various techniques described herein. In one implementation, method 100 may be performed by any computing device, such as computer system 700, described in FIG. 7. It should be understood that while the flow diagram of method 100 indicates a particular order of execution of operations, in some implementations, certain portions of the operations may be executed in a different order. Certain portions of the operations may be executed simultaneously. Further, in some implementations, additional operations or steps may be added to the method 100 illustrated in the flow diagram. Likewise, some operations or steps may be omitted. Additionally, the operations may be executed on more than one computerized device, and the computerized devices may be in more than one location.

At block 110, the method 100 may receive a desired uptime for one or more pieces of equipment. A desired uptime may have a number of meanings, depending on the industry and applications. In one implementation, the desired uptime may correspond to the percentage of total calendar time that the equipment is scheduled for operation. For example, if a piece of equipment were scheduled to operate each day for six hours, the uptime would be twenty five percent. In another implementation, the desired uptime may correspond to the percentage of scheduled time that the equipment is available to operate. For example, if a piece of equipment were scheduled to operate six hours per day, but due to malfunctions was only available to operate for three hours per day, the uptime would be fifty percent. In another example, if the piece of equipment is an airplane, at block 110 the received desired uptime may be that the airplane should be available to fly 85% of the airplane's scheduled routes. The desired uptime may correspond to the speed at which the equipment runs as a percentage of the equipment's designed or desired speed. For example, if a mail sorting machine were designed to sort twenty thousand letters per hour, but the machine only sorted fifteen thousand letters per hour, the machine's uptime would be seventy five percent. The received desired uptime may correspond to the quality of the equipment's production. For example, if a mail sorting machine sorted mail with an error rate of five letters out of every hundred, the uptime for the mail sorting machine would be ninety five percent.

At block 120, method 100 may receive a set of supplies or actions used to maintain the equipment. For example, if the equipment is a vehicle, the method may receive a set of replacement parts for the vehicle, such as a new tire, and a set of actions used to maintain the equipment, such as performing an oil change. The set may be a weighted priority list, where supplies that are replaced frequently or actions that are performed frequently have a higher priority. The priorities may be determined by examining maintenance records for the equipment, or by user input.

At block 130, method 100 may receive information describing the current state of the equipment. In one implementation, method 100 may receive maintenance records for the equipment. For example, method 100 may receive a list describing what repairs have been made to a piece of equipment and when those repairs were made. Method 100 may also receive any other information regarding the current state of the equipment. For example, the method may receive information describing the current functionality of the equipment, whether any parts of the equipment are known to be broken, whether any error messages or warning lights exist on the equipment, and whether any maintenance is scheduled for the equipment.

At block 140, method 100 may use probability analysis, the set of supplies or actions received at block 120, and the information describing the current state of the equipment received at block 130 to determine a series of actions that may be used to achieve the desired uptime. The actions may include ordering supplies, e.g., replacement parts, moving supplies, performing maintenance, instructions describing how equipment should be operated, or other actions related to equipment uptime. Probability analysis may be used to estimate when a piece of equipment will fail, and why the equipment will fail. For example, if the pieces of equipment are ten mail sorting machines, the actions may include a schedule of when replacement parts or other supplies should be ordered to achieve the desired uptime for the mail sorting machines, and the actions may also include when maintenance should be performed on the sorting machines.

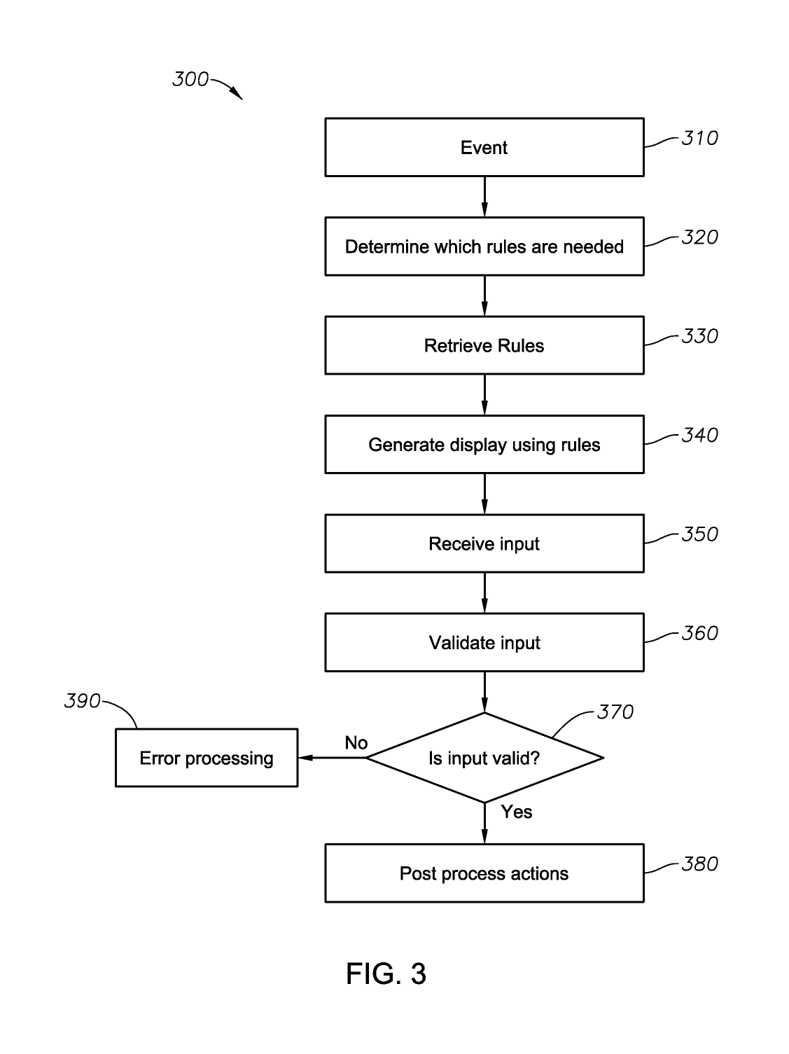

At block 150, method 100 may create one or more milestones corresponding to the actions determined at block 140. For example, if replacement parts must be ordered, a milestone might be created for a user to place an order for the supplies. In another example, if maintenance must be completed on a piece of equipment, a milestone for a user may be created, where the user is instructed to perform the maintenance in order to complete the milestone. Milestone creation and completion is further described in FIGS. 3-6.

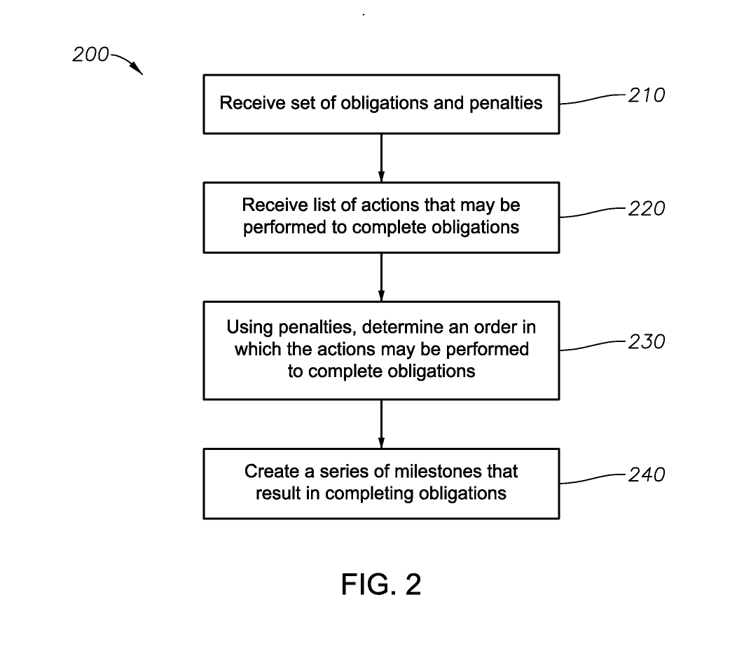

FIG. 2 illustrates a flow diagram of a method for completing contractual obligations in accordance with implementations of various techniques described herein. In one implementation, method 200 may be performed by any computing device, such as computer system 700, described in FIG. 7. It should be understood that while the flow diagram of method 200 indicates a particular order of execution of operations, in some implementations, certain portions of the operations may be executed in a different order. Certain portions of the operations may be executed simultaneously. Further, in some implementations, additional operations or steps may be added to the method 200 illustrated in the flow diagram. Likewise, some operations or steps may be omitted. Additionally, the operations may be executed on more than one computerized device, and the computerized devices may be in more than one location.

At block 210, method 200 may receive a set of obligations and penalties. The obligations may be contractual obligations. The penalties may be penalties for failing to complete the contractual obligations. The obligations and penalties may be input as a spreadsheet or database. For example, method 200 may receive a set of orders that have not yet been completed, and penalties for failing to complete the orders within a certain time. In another example, an aircraft maintenance organization may have a set of contractual obligations for one client that requires 85% uptime for their planes or there is a penalty of $5000 per plane per day, and for a second client that requires 90% uptime for their planes with a penalty of $1000 per plane per day.

At block 220, method 200 may receive a set of actions that may be performed to complete the obligations received at block 210. The set may be a weighted priority list. The priorities may be determined based on the order in which prior obligations were completed, or based on user input. For example, if the obligations received at block 210 are two orders for goods, the actions may include two actions corresponding to shipping the goods for each order. In another example, if one of the obligations received at block 210 includes performing a complex repair on an airplane, a large number of actions may be received corresponding to the complex repair. In one implementation, instead of receiving the list of actions, the list of actions may be generated using the contractual obligations received at block 210.

At block 230, method 200 may examine the penalties to determine an order in which the actions received at block 220 may be performed to complete the obligations. Method 200 may determine an order that minimizes penalties, maximizes profits, or both. For example, if two orders are received and only one can be completed in time to avoid a penalty, the order of the actions may correspond to first completing the order that has the greater penalty for late shipment. Thus, the penalty would be minimized because the order shipped late would have a lower penalty than the order shipped on time. Method 200 may examine factors other than penalties when determining the order in which the actions may be performed. For example, certain customers may be favored, so actions corresponding to those clients may receive priority.

At block 240, method 200 may create one or more milestones corresponding to the actions determined at block 230. For example, if an order in which goods are to be shipped is determined, milestones may be generated that require users to ship the goods in the order determined at block 230. In another example, if two airplanes require the same replacement piece, but only one replacement piece is available, a first milestone may be created corresponding to replacing the piece on one of the airplanes, and a second milestone may be created wherein a user is instructed to order a replacement piece. In this example, the first and second milestone may be completed simultaneously. Milestone creation and completion is further described in FIGS. 3-6.

FIG. 3 illustrates a flow diagram of a method 300 for milestone management in accordance with implementations of various techniques described herein. In one implementation, method 300 may be performed by any computing device, such as computer system 700, described in FIG. 7. It should be understood that while the flow diagram of method 300 indicates a particular order of execution of operations, in some implementations, certain portions of the operations may be executed in a different order. Certain portions of the operations may be executed simultaneously. Further, in some implementations, additional operations or steps may be added to the method 300 illustrated in the flow diagram. Likewise, some operations or steps may be omitted. Additionally, the operations may be executed on more than one computerized device, and the computerized devices may be in more than one location.

At block 310, an event may occur, triggering the milestone management process 300. The event may be the completion of methods 100 or 200. The event may be the creation of one or more milestones at block 150 or 240. The event may be receiving information describing one or more obligations or one or more milestones. For example, at block 150, method 100 may create a series of milestones instructing a user to order supplies, thereby triggering milestone management process 300. In another example, at block 240, method 100 may create a series of milestones instructions that correspond to the completion of an obligation, thereby triggering milestone management process 300. The event may be a business occurrence, the completion of a milestone, receiving user input, or any other occurrence. The events that trigger method 300 may be defined for an individual user, project, or organization. For example, a user logging in to a system may be an event that triggers method 300. In another example, a user may select a button on a user interface to indicate that a new order should be placed.

At block 320, method 300 may determine which rules are needed to process the event at block 310. Different types of events, users, organizations, or projects may require different types of rules. The rules may include display rules, flow rules, business rules, fulfillment rules, data rules, and notification rules.

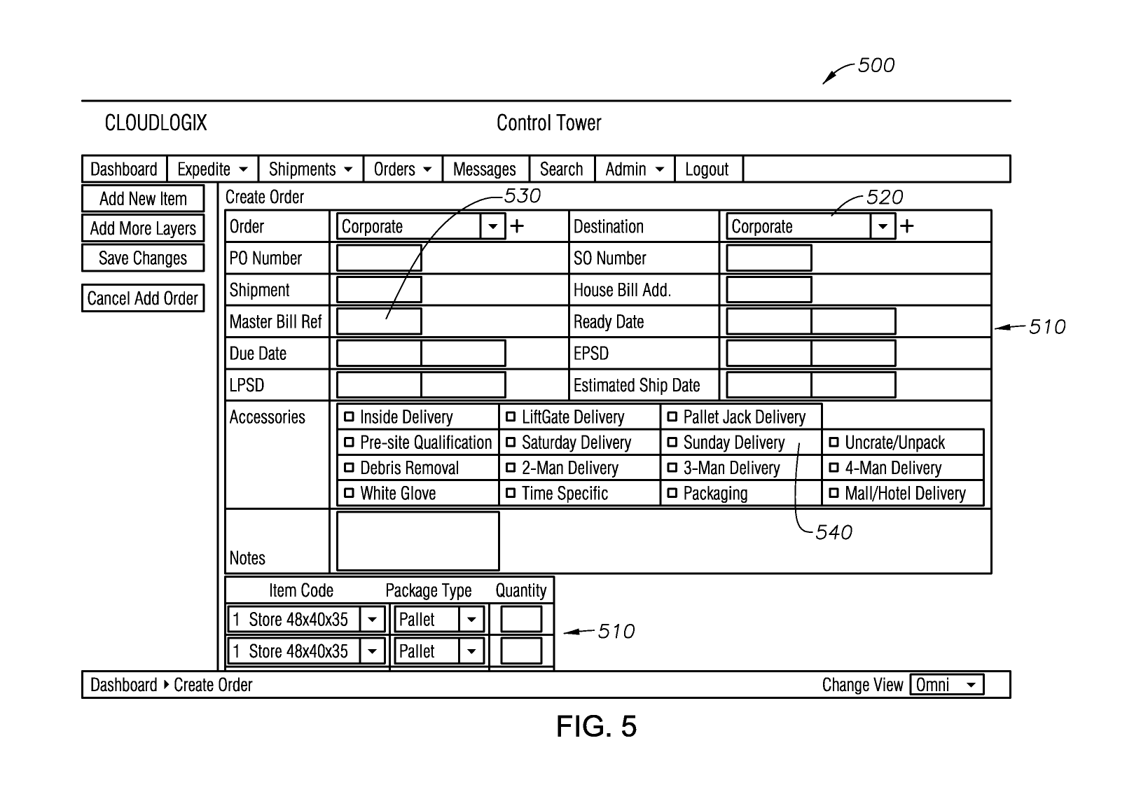

Display rules may include instructions describing the types of displays that should be created for a user while managing a milestone. FIG. 5 is an example of a display that may be generated using display rules.

Flow rules may determine what should occur after the completion of a milestone. For example, after the completion of a first milestone, flow rules may determine the milestone that should be completed next.

Business rules may be specific to an organization and may include organization specific requirements for business processes. For example, in one organization, business rules may dictate that an order cannot be shipped prior to two weeks before the last possible ship date for the order. In another example, business rules may dictate that a new customer cannot be entered without a phone number.

Fulfillment rules may detail the requirements for completing a milestone. For example, fulfillment rules may require a user to upload a document in order to complete a milestone.

Data rules may include instructions regarding how to parse or interpret data. For example, if a spreadsheet is input, data rules may detail where data in the spreadsheet should be stored.

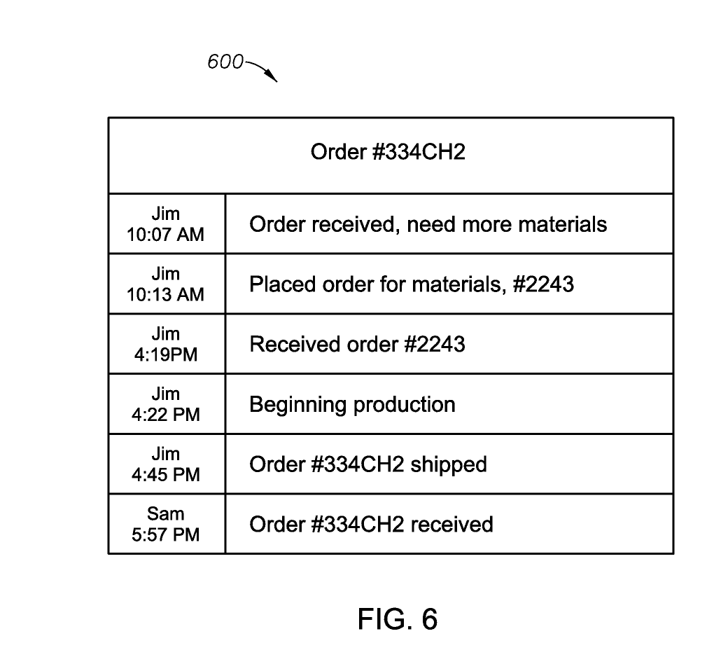

Notification rules may be used for social networking aspects of milestone management. For example, if an order is cancelled, notification rules may send a message to an administrator notifying the administrator of the cancellation. FIG. 6 is an example of a display showing notifications that may be generated using notification rules.

In one example, if the event at block 310 is a user logging in to a system, method 300 will determine the display rules to be retrieved in order to generate a display for the user. In another example, if the event at block 310 is a new order being placed, such as an order for supplies generated at block 150, method 300 will determine at block 320 the display rules to be retrieved in order to display an order entry interface, the fulfillment rules to be retrieved in order to validate the input entered using the interface, the notification rules to be retrieved in order to transmit a social networking message to an administrator stating that an order has occurred, and the data rules to be retrieved to determine where information contained within the order should be stored.

At block 330, once the particular rules have been determined, method 300 retrieves the rules needed to process the event. The retrieved rules may be display rules, flow rules, business rules, fulfillment rules, data rules, or notification rules, as determined in block 320. In one implementation, the rules may be organized in a hierarchical manner. The hierarchy may be, from the most specific to the broadest, event, user, role, project, site, customer, and client, where the customer is the client's customer.

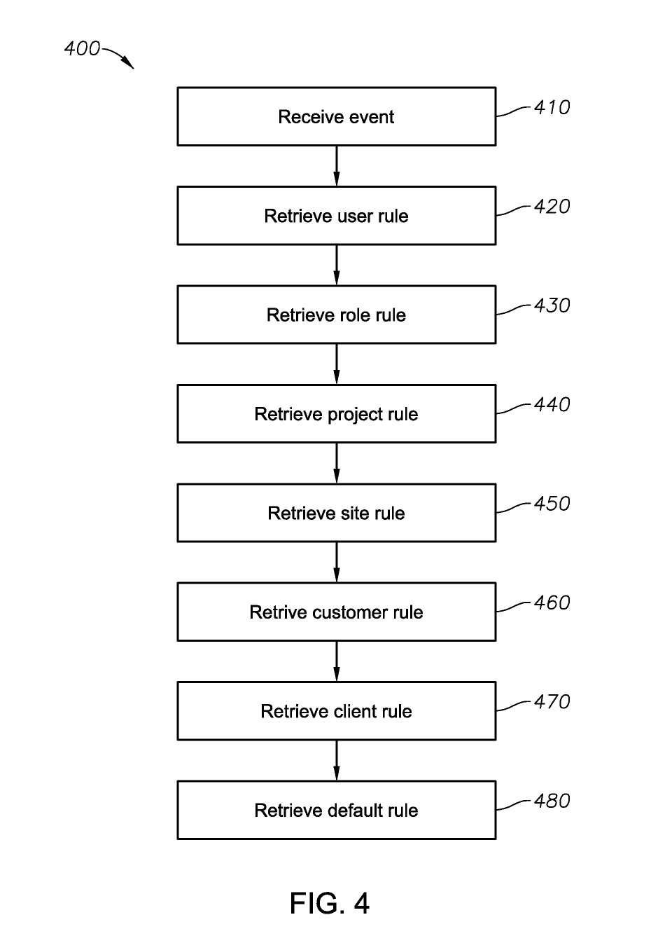

In one implementation, the rules may be retrieved using a hierarchical fetch, which is further described in FIG. 4 in more detail. The hierarchical fetch is configured to ultimately retrieve the most specific rule applicable to the event. Regardless of where the hierarchical fetch starts, i.e., most specific rule or broadest rule, the hierarchical fetch will ultimately retrieve the most specific rule.

For example, one installation of a cloud software service using method 300 may have one client with three different customers who each have two different projects, for a total of six different projects, and there may be different rules for each project and different rules for each customer. Method 300 is called to retrieve rules for an event associated with project X for customer Y. In this example, the broadest rule may be retrieved first. As such, the customer rules for customer Y may be retrieved first, and then the project rules for project X may be retrieved. If project rules exist for project X, then only the project rules are used as the rules for the event, but if project rules for project X do not exist, then the customer Y rules are used as the rules for the event. In this manner, the most specific rule is ultimately retrieved.

In another implementation, the retrieved rules at each hierarchical level may be combined. Using the same example, when retrieving rules for an event associated with project X and customer Y, the customer rules for customer Y and project rules for project X may be combined to form the set of rules used for the event.

The rules retrieved at block 330 may be customized based on how the milestone management method 300 is used. That is, the rules may be customized based on a variety of factors, e.g., the industry, the user's preferences, the user's client's preferences, the type of project, and the like. For example, a first user may use milestone management method 300 with a first set of rules for achieving a desired equipment uptime, and a second user may use milestone management method 300 with a second set of rules to complete obligations, which is a different application from achieving a desired uptime. Although the milestones that will occur and requirements for each milestone may be different for the first user and the second user, the same milestone management method 300, with two different sets of rules, may be used for both applications.

At block 340, a display may be generated based on the display rules that were retrieved at the previous step. In some implementations, other rules, e.g., flow rules, business rules, fulfillment rules, data rules, notification rules, etc., may be used to generate the display. The display rules may be applied to data from the event, data that is input, data that is retrieved, or combinations thereof. In one implementation, the display may include reports, spreadsheets, web pages or interfaces. In another implementation, at block 340, notifications, emails or text messages may be generated and transmitted according to the display rules and notification rules. FIG. 5 illustrates an example of an interface that may be generated at block 340 using display rules. For example, if the event at 310 is a selection indicating that a new order should be placed, FIG. 5 may be displayed at block 340. The interfaces generated at block 340 may allow a user to input information, including text, spreadsheets, documents, images, or any other type of input. For example, in FIG. 5, a user may enter information corresponding to a new order, including shipping number, ship date, Purchase Order (PO) number, and other information describing the new order.

At block 350, method 300 may receive input. In one implementation, method 300 may receive input using a form generated at block 340. For example, FIG. 5 may be displayed, and a user may enter input using the forms in FIG. 5. In another implementation, method 300 may receive a spreadsheet and use data rules to extract input data from the spreadsheet. The input received at block 350 may include data corresponding to the completion of a milestone. For example, if a “ship goods” milestone is generated at block 240 in order to complete an obligation, the input may be a tracking number of the shipped goods and an image of a packing slip, thus confirming that the goods have been shipped and that the milestone is complete.

At block 360, method 300 may validate the input received at block 350. Method 300 may use fulfillment rules and business rules to validate the input. Fulfillment rules may be used to determine whether all information required to complete a milestone was input. Business rules may be used to determine whether the input is consistent with the rules used by an organization. For example, in an organization that requires all orders over a given price to be approved by an administrator, the business rules may determine whether the approval is necessary and whether the approval has been received. In another example, if FIG. 5 is displayed at block 340, and input is received from FIG. 5 at block 350, fulfillment rules may be used at block 360 to determine whether all of the required information to place a new order is included in the input.

At block 370, method 300 may determine whether the input was validated or not, and if not, error processing may occur at block 390. During error processing at block 390, a user may be notified that an error has occurred. Additionally, error processing may describe the missing information or the cause of the error. Additionally, the user may be able to correct the error at block 390. In one example, form 500 in FIG. 5 is displayed at block 340, input is received at block 350 from the form 500 but the input received at block 350 does not include a PO number. The input may then be found to be invalid at block 360 based on the fulfillment rules retrieved at block 330. Error processing at block 390 may allow a user to complete form 500, by entering a PO number, and the method may then proceed to block 380.

If the input is validated, method 300 may proceed to block 380. At block 380, post process actions may occur. In one implementation, flow rules may be used to determine the post process actions. For example, if the milestone being completed in blocks 310-370 is fulfilling a new order, the post process actions at 380 may include generating another milestone in which the order must be packed. Additionally, notification rules may be used to generate social notifications after a process has completed. Post process actions may also include the generation of reports.

FIG. 4 illustrates a hierarchical rule fetch method 400 in accordance with implementations of various techniques described herein. In one implementation, method 500 may be performed by any computing device, such as computer system 700, described in FIG. 7. It should be understood that while the flow diagram of method 400 indicates a particular order of execution of operations, in some implementations, certain portions of the operations may be executed in a different order. Certain portions of the operations may be executed simultaneously. Further, in some implementations, additional operations or steps may be added to the method 400 illustrated in the flow diagram. Likewise, some operations or steps may be omitted. Additionally, the operations may be executed on more than one computerized device, and the computerized devices may be in more than one location.

Hierarchical rule fetch 400 may be used to retrieve rules at block 330 in FIG. 3. Hierarchical rule fetch 400 may receive an event and then traverse a set of rules to find the rules applicable to the event. The traversed set of rules may include display rules, flow rules, business rules, fulfillment rules, data rules, notification rules, or any other rules. Hierarchical rules may be indexed using any hierarchy. In one implementation, the hierarchy may be, from broadest to most specific, client specific rules, customer specific rules, site specific rules, project specific rules, role specific rules, and user specific rules. At block 410, the hierarchical rule fetch method 400 may receive an event. The hierarchical rule fetch method may then extract or determine the hierarchical information for the event. That is, the method may determine the user, role, project, site, customer, and client associated with the event, or some subset of that information. For example, if the event is a new order being placed, the method may determine which client the order was placed at, which customer placed the order, and which project the order is for.

After determining or retrieving the hierarchical information for the received event, method 400 may retrieve the rules corresponding to the event. In one implementation, a filter may be created using the hierarchical information for the event. The filter may then be applied to a database of rules to retrieve the rules corresponding to the event. For example, the filter may be a database query created using the hierarchical information for an event.

The hierarchical fetch may proceed from most specific rule, at block 420, to broadest, at block 480. At block 420, method 400 may attempt to retrieve the user specific rules. If user specific rules exist, then method 400 will retrieve the user specific rules and method 400 is complete. If not, method 400 may attempt to retrieve role specific rules at block 430. If role specific rules exist, then method 400 will retrieve the role specific rules and method 400 is complete. If not, method 400 may attempt to retrieve project specific rules at block 440. If project specific rules exist, then method 400 will retrieve the project specific rules and method 400 is complete. If not, method 400 may attempt to retrieve site specific rules at block 450. If site specific rules exist, then method 400 will retrieve the site specific rules and method 400 is complete. If not, method 400 may attempt to retrieve customer specific rules at block 460. If customer specific rules exist, then method 400 will retrieve the customer specific rules and method 400 is complete. If not, method 400 may attempt to retrieve client specific rules at block 470. If client specific rules exist, then method 400 will retrieve the client specific rules and method 400 is complete. If not, the method may retrieve default rules at block 480.

In another implementation, hierarchical fetch method 400 may begin at the broadest rules and proceed to the most specific rules. For example, the fetch may first retrieve the default rules. Then, the fetch may retrieve the client rules. If client rules exist, the client rules will supersede the default rules. So, the client rules would be the rules used, not the default rules. Then, the method may retrieve the customer rules. If customer rules exist, the customer rules would supersede the client rules and the default rules. This process may continue until the most specific hierarchy has been reached.

In one implementation, at block 410, the method may extract the most specific hierarchical information from the event, and then use external information to determine the remaining hierarchical information for the event. For example, the method may extract the project information for an event. The method may then retrieve data from a database, where the data indicates that the project is assigned to a specific customer and client. Thus, the method may then know that the customer, client, and project corresponding to the event.

FIG. 5 illustrates a milestone input interface 500 in accordance with various implementations described herein. Milestone input interface 500 is an example of an interface that may be generated by method 300 using display rules at block 340 in FIG. 3. For example, the display rules retrieved at block 330 may contain instructions for method 300 to generate two tables 510. The rules may instruct method 300 to generate an interface with dropdown lists 520, text input boxes 530, and checkboxes 540. Other types of user interfaces may be displayed as well. The interface 500 may be completely dynamic. For example, every element in the interface 500 may be generated using rules. Once data has been entered into interface 500, the data may be validated using fulfillment rules and business rules, and stored using data rules.

FIG. 6 illustrates an order-specific message display interface 600 in accordance with various implementations described herein. The interface 600 may display messages received by a user. Messages may be automatically generated using notification rules at block 380 in FIG. 3. Users using an interface may also create messages, and the messages may then be transmitted to another user. Messages shown in interface 600 may provide a way for different users responsible for milestones to communicate. Messages may be used to provide users with information or reminders regarding milestones. Messages may be used to notify a user of information that requires attention.

The messages displayed in order-specific message display interface 600 are all related to a single order. For example, the order may be an order for supplies created at block 150. At 10:07 am, Jim, a user employed at the supplier who received the order for supplies and determined that more materials were needed, sent a message including that information. Jim then sent another message at 10:13 am to state that an order for materials was placed, and that the order number is 2243. At 4:19 pm, Jim sends a message confirming that the order for materials number 2243 has been received, and at 4:22 pm Jim sends a message stating that production on the order for supplies has begun. Jim sends a message once production is complete and the order for supplies has been shipped, at 4:45 pm, stating that the order for supplies has been shipped. Then, at 5:57 pm, Sam, who placed the order for supplies, sends a message stating that the order for supplies has been received. The message display interface 600 may allow a user to quickly view all messages relevant to an order. The interface 600 may be sorted by time sent, time received, relevance, whether or not a message has been read, or using any other factor. Although the interface 600 displays messages relevant to an order, the interface 600 may display messages relevant to a milestone, a user, a project, or any other criteria.

### COMPUTING SYSTEM

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, smart phones, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments, including a cloud computing environment, where tasks are performed by remote processing devices that are linked through a communications network, e.g., by hardwired links, wireless links, or combinations thereof. In a distributed computing environment, program modules may be located in both local and remote computer storage media including memory storage devices.

FIG. 7 illustrates a computer system 700 into which implementations of various technologies and techniques described herein may be implemented. Computing system 700 may be a conventional desktop, a server computer, a laptop, a tablet, or part of a cloud computing system. It should be noted, however, that other computer system configurations may be used.

The computing system 700 may include a central processing unit (CPU) 721, a system memory 722 and a system bus 723 that couples various system components including the system memory 722 to the CPU 721. Although only one CPU is illustrated in FIG. 7, it should be understood that in some implementations the computing system 700 may include more than one CPU. The system bus 723 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 722 may include a read only memory (ROM) 724 and a random access memory (RAM) 725. A basic input/output system (BIOS) 726, containing the basic routines that help transfer information between elements within the computing system 700, such as during start-up, may be stored in the ROM 724. The computing system may be implemented using a printed circuit board containing various components including processing units, data storage memory, and connectors.

The computing system 700 may further include a hard disk drive 727 for reading from and writing to a hard disk, a magnetic disk drive 728 for reading from and writing to a removable magnetic disk 729, and an optical disk drive 730 for reading from and writing to a removable optical disk 731, such as a CD ROM or other optical media. The hard disk drive 727, the magnetic disk drive 728, and the optical disk drive 730 may be connected to the system bus 723 by a hard disk drive interface 732, a magnetic disk drive interface 733, and an optical drive interface 734, respectively. The drives and their associated computer-readable media may provide nonvolatile storage of computer-readable instructions, data structures, program modules and other data for the computing system 700.

Although the computing system 700 is described herein as having a hard disk, a removable magnetic disk 729 and a removable optical disk 731, it should be appreciated by those skilled in the art that the computing system 700 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 700. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 727, magnetic disk 729, optical disk 731, ROM 724 or RAM 725, including an operating system 735, one or more application programs 736, program data 738, and a database system 755. The one or more application programs 736 may contain program instructions configured to perform methods 100, 200, 300, or 400 according to various implementations described herein. The operating system 735 may be any suitable operating system that may control the operation of a networked personal or server computer, such as Windows® XP, Mac OS® X, Unix-variants (e.g., Linux® and BSD®), and the like.

A user may enter commands and information into the computing system 700 through input devices such as a keyboard 740 and pointing device 742. Other input devices may include a microphone, joystick, game pad, satellite dish, scanner, user input button, or the like. These and other input devices may be connected to the CPU 721 through a serial port interface 746 coupled to system bus 723, but may be connected by other interfaces, such as a parallel port, game port or a universal serial bus (USB). A monitor 747 or other type of display device may also be connected to system bus 723 via an interface, such as a video adapter 748. In addition to the monitor 747, the computing system 700 may further include other peripheral output devices such as speakers and printers.

Further, the computing system 700 may operate in a networked environment using logical connections to one or more remote computers 749. The logical connections may be any connection that is commonplace in offices, enterprise-wide computer networks, intranets, and the Internet, such as local area network (LAN) 751 and a wide area network (WAN) 752. The remote computers 749 may each include application programs 736 similar to that as described above.

When using a LAN networking environment, the computing system 700 may be connected to the local network 751 through a network interface or adapter 753. When used in a WAN networking environment, the computing system 700 may include a modem 754, wireless router or other means for establishing communication over a wide area network 752, such as the Internet. The modem 754, which may be internal or external, may be connected to the system bus 723 via the serial port interface 746. In a networked environment, program modules depicted relative to the computing system 700, or portions thereof, may be stored in a remote memory storage device 750. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon computer-executable instructions which, when executed by a computer, cause the computer to:
receive a desired uptime for one or more pieces of equipment;
receive a set of supplies used in maintaining the one or more pieces of equipment;
determine a plurality of actions for achieving the desired uptime based on a probability analysis of one or more maintenance records for the one or more pieces of equipment, wherein the plurality of actions comprises ordering one or more supplies in the set of supplies; and
create one or more milestones from the plurality of actions.

2. The non-transitory computer-readable medium of claim 1, further comprising executable instructions that cause the computer to receive a set of maintenance actions used in maintaining the one or more pieces of equipment.

3. The non-transitory computer-readable medium of claim 2, wherein the plurality of actions further comprise performing one or more maintenance actions in the set of maintenance actions.

4. The non-transitory computer-readable medium of claim 1, wherein the desired uptime comprises a percentage time that the one or more pieces of equipment are available to operate out of an amount of time that the one or more pieces of equipment are scheduled to operate.

5. The non-transitory computer-readable medium of claim 1, wherein the executable instructions that cause the computer to create the one or more milestones comprise executable instructions that cause the computer to:
receive information describing the one or more milestones;
perform a hierarchical fetch to retrieve a set of rules corresponding to the one or more milestones;
use the set of rules to create an interface; and
display the interface.

6. The non-transitory computer-readable medium of claim 5, wherein the set of rules comprises display rules, flow rules, business rules, fulfillment rules, data rules, notification rules, or combinations thereof.

7. The non-transitory computer-readable medium of claim 5, wherein the executable instructions that cause the computer to create the one or more milestones further comprise executable instructions that cause the computer to use a portion of the set of rules to transmit a message corresponding to the completion of the one or more milestones, the failure to complete the one or more milestones, or a delay in the completion of the one or more milestones.

8. The non-transitory computer-readable medium of claim 1, wherein the set of supplies is a weighted priority list.

9. A non-transitory computer-readable medium having stored thereon computer-executable instructions which, when executed by a computer, cause the computer to:
receive a desired uptime for one or more pieces of equipment;
receive a set of maintenance actions used in maintaining the one or more pieces of equipment;
determine a plurality of actions for achieving the desired uptime based on a probability analysis of one or more maintenance records for the one or more pieces of equipment, wherein the plurality of actions comprises performing one or more maintenance actions in the set of maintenance actions; and
create one or more milestones from the plurality of actions.

10. The non-transitory computer-readable medium of claim 9, wherein the desired uptime comprises a percentage time that the one or more pieces of equipment are available to operate out of an amount of time that the one or more pieces of equipment are scheduled to operate.

11. The non-transitory computer-readable medium of claim 9, wherein the set of maintenance actions is a weighted priority list.

12. The non-transitory computer-readable medium of claim 9, wherein the executable instructions that cause the computer to create the one or more milestones comprise executable instructions that cause the computer to:
receive information describing the one or more milestones;
perform a hierarchical fetch to retrieve a set of rules corresponding to the one or more milestones;
use the set of rules to create an interface; and
display the interface.

13. The non-transitory computer-readable medium of claim 12, wherein the set of rules comprises display rules, flow rules, business rules, fulfillment rules, data rules, notification rules, or combinations thereof.

14. The non-transitory computer-readable medium of claim 12, wherein the executable instructions that cause the computer to create the one or more milestones further comprise executable instructions that cause the computer to use a portion of the set of rules to transmit a message corresponding to the completion of the one or more milestones, the failure to complete the one or more milestones, or a delay in the completion of the one or more milestones.

15. A non-transitory computer-readable medium having stored thereon computer-executable instructions which, when executed by a computer, cause the computer to:
receive a set of contractual obligations;
receive a set of penalties corresponding to the contractual obligations;
use the set of penalties and the set of contractual obligations to determine an order in which the contractual obligations in the set of contractual obligations are to be completed to reduce the amount of penalties;
create one or more milestones, wherein the one or more milestones comprise completing one or more of the contractual obligations in the determined order.

16. The non-transitory computer-readable medium of claim 15, wherein the set of penalties describe penalties for failing to complete obligations in the set of contractual obligations.

17. The non-transitory computer-readable medium of claim 15, wherein the executable instructions that cause the computer to determine the order in which the obligations are to be completed comprises executable instructions that cause the computer to first complete a contractual obligation having the highest penalty in the set of contractual obligations.

18. The non-transitory computer-readable medium of claim 15, wherein executable instructions that cause the computer to create the one or more milestones comprise executable instructions that cause the computer to:
receive information describing the one or more milestones;
perform a hierarchical fetch to retrieve a set of rules corresponding to the one or more milestones;
using the set of rules to create an interface; and
displaying the interface.

19. The non-transitory computer-readable medium of claim 18, wherein the set of rules comprises display rules, flow rules, business rules, fulfillment rules, data rules, notification rules, or combinations thereof.

20. The non-transitory computer-readable medium of claim 18, wherein the executable instructions that cause the computer to create the one or more milestones further comprise executable instructions that cause the computer to use a portion of the set of rules to transmit a message corresponding to the completion of the one or more milestones, the failure to complete the one or more milestones, or a delay in the completion of the one or more milestones.
